(19) United States
(12) Patent Application Publication
(10) Pub. No.: US 2005/0109789 A1
(43) Pub. Date: May 26, 2005

(54) Roll paper feeder

(76) Inventor: Katsumi Nagayoshi, Tokyo (JP)

Correspondence Address: A Professional Corporation, Post Office Box 2926, Kings Beach, CA, 96143-2926, US

(21) Appl. No.: 10/997,506

(22) Filed: Nov. 24, 2004

(30) Foreign Application Priority Data
May 14, 2003 (WO) PCT/JP03/05999

(51) Int. Cl. G07F 11/72

(52) U.S. Cl. 221/32; 221/30

(57) ABSTRACT

Disclosed is an automatic roll paper feeder that has no switch on its face to be operated by a user and includes a sensor that reads the user starting or ceasing to pull out paper from the roll by monitoring movement of the paper. A signal from the sensor triggers a control program and causes the feeder to automatically cut and dispense the paper under the control program, thus eliminating the need for a user to act on any switch to operate the feeder. The feeder through movement of paper can read out the user's will precisely. The invention enables a handicapped user (e. g., one-armed, blind, aged or very young) to easily pull out and sever paper with one hand from a paper roll such as a toilet paper, cooking paper or paper towel in the form of a roll.

### TECHNICAL FIELD

The present invention relates to a roll paper feeder that enables a handicapped user such as a one-armed, blind or aged person or young child, too, to easily pull out paper from a paper roll, e. g., a roll of toilet paper, cooking paper or paper towel, and to have the paper safely cut or severed, with one hand. And, it relates to a roll paper feeder that need not be operated by the user consciously with a switch or switches.

### BACKGROUND ART

In the use of a paper holder that has come into wide use in general in utilizing paper from a paper roll, the user holds down a holder's cover having a blade or cutting edge with one of its hands and seizes the end of paper with the other hand and then pulls the paper forcibly to cut it with the blade. Such a series of operations requires the user to use its both hands at the same time and are arduous to persons who are handicapped with the hand, the vision or otherwise the age and to young children. Accordingly, intended to lessen this difficulty even slightly, a paper holder has been proposed and commercialized in which the cover having the cutting means has an accessory such as a spring added thereto such that the cutting edge of the cover can be resiliently pressed against the paper roll with a force not much impeding the paper from being pulled out to allow the paper to be pulled out and cut one-handed. Even then, however, paper cannot be either pulled out or cut without fail unless the direction in which and the speed at which the paper is to be pulled out and the direction in which, the speed at which and the force with which the paper is to be pulled for its cutting are properly adjusted. Above all, however, irrespective of whether or not the cover having the cutting edge has a spring or the like, in either case the end paper left on the side of a paper roll after the paper is cut is left on the hidden side of the cutting edge and is made invisible. For this reason, a next user is required first to rotate the paper roll with the hand in the paper-pullout direction to an extent where the user can see and touch the end of paper. The user is then required to use fingers and nails to tear off the paper end which when cut was pressed and has then stuck fast to the paper roll. Such an operation is extremely hard to do for a person who is poor in or completely lost of vision and further has one arm lost and the other, skillful arm injured and bandaged on its fingers.

Aimed to resolve these inconveniences, inventions relating to a manually or electrically operated automatic roll paper feeder have come to appear increasingly in published patent applications in recent years. Although the applicant at the date of the present patent application has never seen any automatic roll paper feeder made concrete and commercialized, the automatic roll paper feeders known as disclosed in these patent applications generally have the components mentioned below. These components are: a paper holder for supporting a paper roll rotatably, an automatic paper feeding device, a feed length adjusting device, a feed length selection switch, an automatic paper cutting device, a part for receiving a sheet of paper cut and separated from the paper roll, an automatic paper feeding device for feeding a length of paper after cutting, switches for actuating these devices, respectively, a control unit for operating each of these devices under a preestablished program, sensors aimed to ensure that these control units operate without fail, timers aimed to ensure that these control units operate without fail, a casing main body for accommodating these devices and units, and a cover for an open space of the casing. These are the basic components of the known automatic roll paper feeders. Many of the inventions and utility models disclosed in the published patent and registration applications recombine these basic components with one another, improve them individually, devise manners of their arrangement and mounting, devise manners of control and programming, and incorporate elements in combination with these basic components in an effort to eliminate the deficiencies of the prior inventions and utility models. However, many of them leave much to be desired in detail and apparently can hardly be utilized in actuality.

In particular, as what becomes an obstacle in the actual use, there is a problem concerning the presence of a switch or switches. All these inventions and utility models in the past require the user to operate a switch such as a standard push-button switch or foot switch or otherwise an infrared detector or sensor switch, where it would be an exceedingly hard task for a person whose vision becomes extremely weak or completely lost to find the presence of a switch and to understand its function, let alone to operate switches for different functions allocated to them, respectively. Also, because of differences in the manner to use of such a conventional automatic roll paper feeder from the paper holder well accustomed in the past, when the accustomed paper holder is, suddenly one day, replaced with the automatic roll paper feeder there will arise the need that a note of operating instructions to explain the manner to operate it be stuck on somewhere on this new apparatus itself or its nearby place, but this should come to merely force further inconvenience on such a visibly handicapped person or a very aged person whose vision has become so weak as to be unable to read the operating instructions. And, it will be in general that such operating instructions must also be of contents that are hard to understand for young children, and that any such new automatic roll paper feeder requiring a switch or switches to be operated must therefore be one hardly acceptable to young children, too. Further, to a person who in mental functions is even slightly sunk, even the presence of only one switch that need be operated may invite a feeling of uneasiness in advance that “How? Something to do? Getting something beyond if it's pushed down?” It is well imaginable that the user cannot even depress a switch and may be totally at a loss about how to use it.

### DISCLOSURE OF THE INVENTION

Accordingly, it is an object of the present invention to provide a roll paper feeder that enables any user, e. g., a one-armed user or a user handicapped in vision, too, to readily pull out paper from a paper roll and then to have the paper cut safely, with one hand and which is capable of reading the user's will through a movement of the paper and which need not be operated by the user consciously with a switch or switches.

A roll paper feeder according to the present invention is characterized by its capability of reading the will of a user through a movement of paper. A roll paper feeder according to the present invention, therefore, need not be operated by the user consciously with a switch or switches, and the user then can easily pull out paper from a paper roll, e. g., a roll of toilet paper, cooking paper or paper towel, with one hand and can then have the paper cut or severed safely. In the absence of any particular switch or switches that must be operated unlike in the prior art, a roll paper feeder according to the present invention can be used readily by a person physically or mentally handicapped, a person who is one-armed due to such as injury, a young child or infant, a very aged person or a person who is lost of vision, too, in a manner as well accustomed in the past and without any sense of incompatibility even at its first use. Also, in a roll paper feeder according to the present invention paper is not fed or dispensed altogether by motor driving as in the known automatic roll paper feeders and in an embodiment thereof can be dispensed only by a length of paper about 10 cm by motor driving. Then, if a length of paper of 1 m to 2 m is pulled out by the user, no electric power is consumed at all for the time interval in which that length of paper is pulled out, meaning that power consumption is reduced to about 1/10 or less of that in the prior-art technique. Thus, if the present invention is commercialized into an independent-type roll paper feeder product powered by a dry battery, the dry battery for the product lasts about 10 times longer, in terms of time of exchange, than a battery of the same time for an automatic roll paper feeder product according to the prior art. A markedly increased energy-saving effect of a roll paper feeder according to the present invention that requires much less power consumption is therefore evident.

### BRIEF DESCRIPTION OF THE DRAWINGS

In the drawings,

FIG. 1 is a perspective view of an embodiment of the present invention;

FIG. 2 is a simplified structural and explanatory view of the embodiment shown in FIG. 1;

FIG. 3 is a simplified structural and explanatory view illustrating functions of paper pressers or presser feet in such an embodiment of the invention;

FIG. 4 is a simplified structural and explanatory view illustrating a state that paper has been cut in such an embodiment of the invention;

FIG. 5 is a simplified structural and explanatory view illustrating a state that a cutting edge has been returned to its initial position in such an embodiment of the invention;

FIG. 6 is a simplified structural and explanatory view illustrating a manner in which to position a light transmission type optical sensor in an embodiment of the invention;

FIG. 7 is a simplified structural and explanatory view illustrating a manner in which to position a light reflection type optical sensor in an embodiment of the invention;

FIG. 8 is a simplified structural and explanatory view of an embodiment of the invention in which a portion of the cover is laterally open;

FIG. 9 is a simplified structural and explanatory view of an embodiment of the invention in which a portion of the cover is laterally open;

FIG. 10 is a simplified structural and explanatory view of an embodiment of the invention in which a trigger switch is provided at a paper exit section;

FIG. 11 is a simplified structural and explanatory view of an embodiment of the invention in which a trigger switch is provided at a paper exit section; and

FIG. 12 is a simplified structural and explanatory view of an embodiment of the invention in which a trigger switch is provided in a paper dispensing device section.

### BEST MODE FOR CARRYING OUT THE INVENTION

Hereinafter, the present invention will be described in detail with reference to the accompanying drawings.

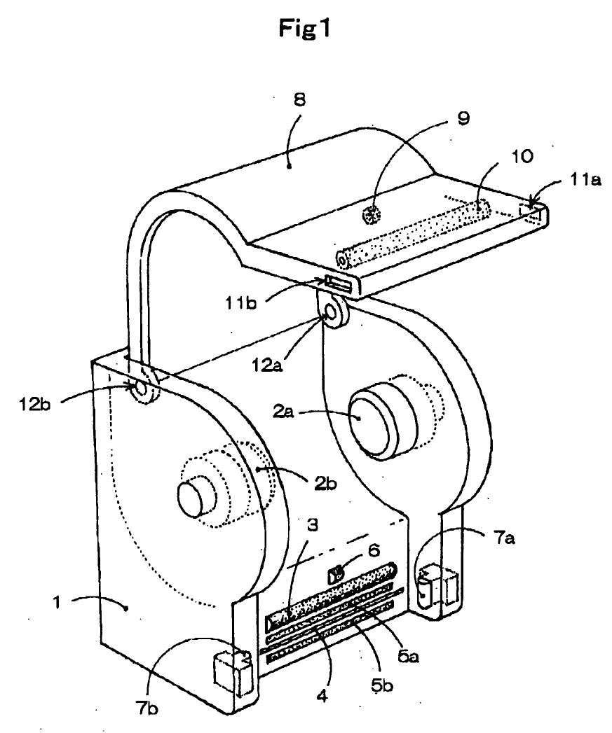

A paper roll feeder (hereinafter referred to also as “apparatus”) as an implementation of the present invention designed to be safe and trouble-free is shown in FIG. 1 in its perspective view. A casing 1 forming a main body of the roll paper feeder has a pair of holders 2a and 2b on which a roll of paper or paper role is rotatably supported, an exit slit 4 for a cutting edge in an automatic paper cutter or cutting device and a pair of locking projections 7a and 7b each containing a spring and, and is furnished with a drive roller 3 in an automatic paper feeding or dispensing device or dispenser for feeding or dispensing a certain length of paper after it is cut, a pair of paper pressers or presser feet 5a and 5b as an accessories of the automatic cutting device, and a sensor 6 for reading or sensing the paper starting and ceasing to move. A cover 8 that can be turned up to open a space in the main body in which to set a paper roll is furnished with a sensor reception or driven roller 9 to operate the sensor 6 normally, a passive or driven roller 10 to operate the paper dispensing device normally and a pair of locking recesses 11a and 11b to fit with the locking projections 7a and 7b in the main body when the cover 8 is turned on fulcrums 12a and 12b into its close position. FIG. 1 shows the cover 8 in its open position to allow the paper roll to be set. In the state shown in FIG. 1, the holders 2a and 2b are held to protrude inwards from the inner wall of the main body and as they are cannot accept the paper roll. The holders 2a and 2b are so designed as in a knock-type ball-point pen that when pushed once from outside they together project inwards and when pushed once again they are withdrawn. Therefore, in order to set the paper roll and bring it into the state that it is rotatably supported by the holders 2a and 2b, they can once be withdrawn from the inner wall of the main body to allow the paper roll to be accepted in the space between them and set there with its center hole or core cylinder aligned with them and they can then be projected into the paper roll core cylinder.

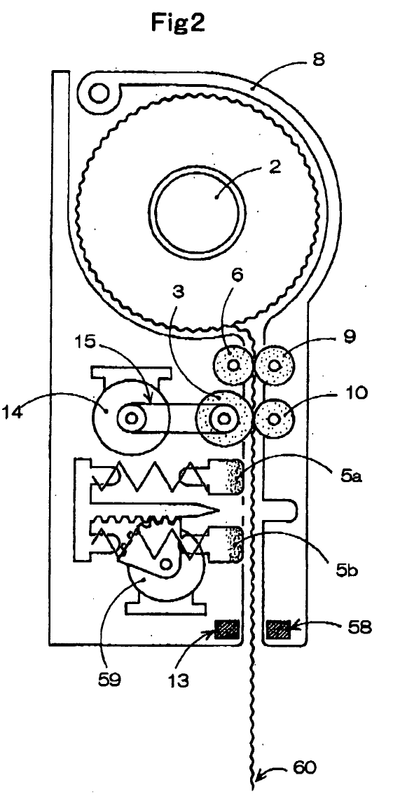

FIG. 2 is a schematic structural and explanatory view of the roll paper feeder of FIG. 1 embodying the present invention, illustrating the roll paper feeder shown with the paper roll set, with the cover in its close position and with an end portion 60 of the paper somewhat protruding from the lower end of the feeder. For the sake of facilitating the illustration, the lower part of the feeder is shown in FIG. 2 as somewhat lengthened longitudinally over that in FIG. 1. Reference characters used in FIG. 2 correspond to those in FIG. 1.

Mention is made below specifically of steps in the use of the apparatus implemented and operations of devices and units making up the apparatus for each of these steps.

Setting a Paper Roll

(1) Turn up the cover to its open position and set a paper roll so it hangs on the holders 2a and 2b. Then, position paper from the roll in its normal path and let its end appear and suspended from the lower end of the casing main body by a length of 3 cm to 8 cm.

Closing the Apparatus

(2) The cover may then be turned down to its close position.

(3) Here, the apparatus is ensured as to both its functionality and safety if in its design the state that the cover has been completely closed is defined as the state that any spacing in which the pendent paper end portion is guided to pass is of a width (0.5 mm or more) in the direction of paper thickness such that the paper can freely pass through the spacing but such as (3.0 mm or less) to reject entry of an infant's finger.

(4) When the cover is completely closed, a sensor 13 included in the casing main body senses a magnetic force exerted by a magnet 58 included in the cover to furnish a signal to a power supply control unit which turns on a first power switch, thereby permitting electric power to be supplied to an electrical system in the apparatus. Such makeup ensures that when and while the cover is open, every operating unit or device in the apparatus becomes and remains de-energized and unactivated, thus assuring its safety while the paper role is being replaced. Instead of the magnet and sensor combination, it is also possible to use a power switch provided in the casing main body in combination with a projection of 6 mm high on the cover. The main switch can be positioned in the innermost recess of a hole drilled in the casing main body so that it can be turned on when the projection on the cover is pressed on it. Making the hole small (e. g., 3 mm) enough to reject entry of an infant's finger ensures sufficient safety.

(5) With the first power switch turned on, the sensor 6 for sensing movement of paper being pulled out becomes active together with other devices and units. In the embodiment shown in FIG. 2, the sensor 6 is a sensor generally of rotary encoder type and the paper is guided between the sensor 6 and the sensor reception roller 9.

(6) The automatic paper dispensing device comprises a motor 14 having a speed reducer and a power transmission pulley, a power transmission belt 15 and a drive roller 3 having a power transmission pulley. The latter power transmission pulley has on its shaft a clutch disconnected from it or a one-way clutch so that even if the motor 14 stands still, the drive roller 3 and the driven roller 10 can freely be rotated in a direction in which the paper is caused to be pulled, thereby permitting the paper to be pulled out at any time. The automatic paper dispensing device may generally be of the type using a pair or pairs of rubber rollers between which paper is taken and fed out, although one by means of pairs of conveyer belts between which paper is caught and fed out is also well known.

Starting to Pull Out Paper and Clamping the Cover

Paper Outlet

(7) When the paper begins to be pulled out with a hand, the sensor 6 reads or senses the paper starting to move.

(8) The sensor 6 outputs a signal that actuates a control unit in a safety unit to turn a second power switch on.

(9) With the second switch turned on, the cover is clamped in its locking position, e. g., electromagnetically. The cover for the purpose of safety is left locked or clamped until as series of operations that follow is accomplished. A specific, presumably the simplest, way of electromagnetic locking here is to use a solenoid or the like whereby the clamping projections 7a and 7b made able to protrude and withdraw freely with springs as described in connection with FIG. 1 is prevented from moving backwards. In the automatic dispensing device for paper from a paper roll here, it is the most dangerous if the cover is opened or a finger is inserted through the paper outlet port at the instant at which the paper cutting device is operated projecting a sharp cutting edge forwards. Accordingly, the cover needs to remain locked or clamped at least until the cutting operation is completed by withdrawing the cutting edge into the inside of the casing main body, and the paper outlet port need be held then small in its width in the direction of paper thickness (specifically to 3 mm or less) enough to reject entry of an infant's finger.

User Ceases Pulling Out Paper

(10) The user having pulled out paper to a desired length either ceases completely pulling out paper or temporarily stops pulling out paper and, when dissatisfied with the length, again starts pulling out paper and completely ceases pulling out paper when a satisfactory length is reached.

(11) The sensor 6 then works to read or sense the paper ceasing to the move. The sensor 6 has a control unit that is programmed to recognize a complete “ceasing” if the stop lasts for, e. g., 0.5 second or more. Then, any halt of pulling-out that only lasts for less than 0.3 second is not taken as “ceasing” but as a “loss of determination” or “temporary stop” to cause the sensor 6 to continue working and wait for a complete “ceasing”.

Cyclic Operation of Automatic Paper Cutting Device

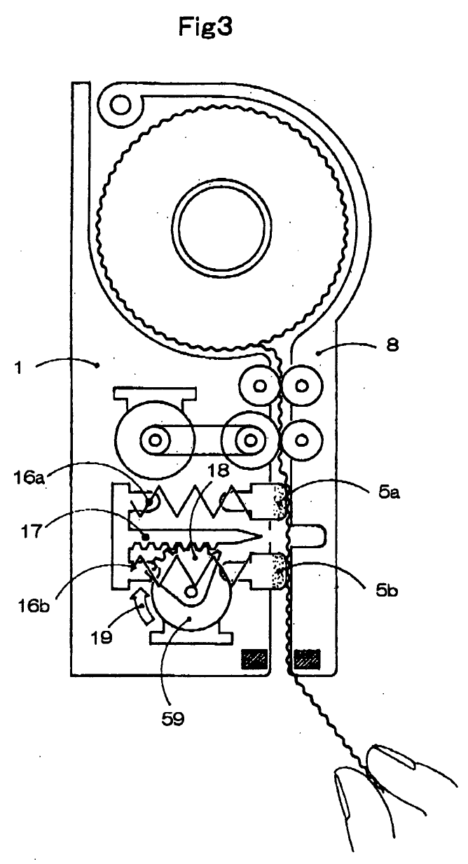

FIG. 3 is a schematic structural and explanatory view of the sensor and automatic paper dispenser systems with them in part omitted for illustrating a cyclic operation of the automatic paper cutting device with the paper pressers inclusive. The fingers seizing the end of paper are shown ceasing to pull out the paper.

(12) The sensor 6 works to transmit the “ceasing” of paper movement to its control unit whereupon the paper pressers 5a and 5b that aid in cutting protrude from the casing main body 1 so that the paper is held between the inner wall of the cover 8 and the pressers 5a, 5b as shown in FIG. 3. Here, the pressers 5a and 5b are attached to a rear end of the cutting edge 17 via compression springs 16a and 16b, respectively. When the motor 59 having the speed reducer commences rotating a gear 18 in the direction of arrow 19, the cutting edge 17 having a rack in mesh with the gear 18 is moved, together with its base as a whole, towards the cover 8 to allow the pressers 5a and 5b to first protrude from the casing main body 1 and then cause them to engage with the paper firm. At this time the tip of the cutting edge has not reached the paper. As the motor 59 continues to rotate the gear 18 in the direction of the arrow 19, the compression springs 16a and 16b are compressed, holding the paper firm with the pressers 5a and 5b. Note here that the paper pressers 5a and 5b preferably have their paper contacting surfaces formed of rubber material having a multitude of small anti-slip projections.

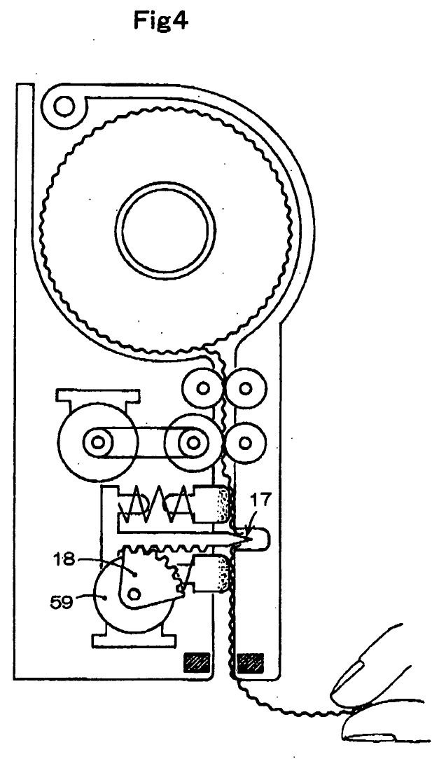

(13) As the motor 59 rotates the gear 18 further in the direction of the arrow 19, a state as shown in FIG. 4 is reached whereby the paper is cut and severed completely by the cutting edge 17. The motor 59 is preferably a motor which having a speed reducer is capable of rotating the gear 18 at a speed suitable for cutting and is also provided with a sensor for reading the angle of rotation of the motor shaft so it can read its angular positions corresponding to the forward and backward positions of the cutting edge, respectively, thereby determining them. The forward and backward positions of the cutting edge can also be determined simply and effectively using an arrangement in which the cutting edge has a projection formed thereon whose positions as representative of its forward and back, ward positions are read by a pair of micro-switches.

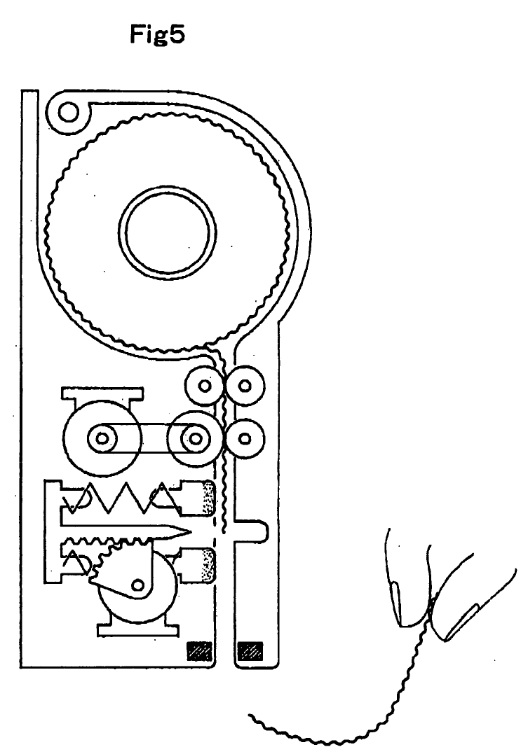

(14) When the paper is cut and severed, the cutting edge 17 and the paper pressers 5a and 5b are returned to the state shown in FIG. 5 past the state shown in FIG. 3. On the other hand, when the paper pressers 5a and 5b are released from holding paper firm, a length of paper severed from the paper roll and leaving from the casing main body is left in the user's hand. The state of the apparatus shown in FIG. 5 is identical to that shown in FIG. 2 except that the end of paper from the paper roll is a severed paper end lying adjacent to the automatic cutter, namely within the casing main body and is thereby prevented from been grasped or touched with fingers. The cutting edge can also be moved forth and back in a known manner by using a forth-and-back slide plate with an elongate hole in combination with a disk with a round projection such that one rotation of the disk having the round projection causes the cutting edge to move forth and back in a single action. JP P H05-111442 A describes a technique of moving a corrugated cutter to cut paper generally with such a setup. Use is also made of a known technique with a fixed cutting edge attached to the cover in conjunction with a rotary cutting edge mounted on the casing main body and rotated by means of a motor or cam so as to cut paper as with scissors or force-cutting blades. Such techniques are described in detail in JP P H10-14811 A, JP P H09-206237 A, JP P H04-20340 B and JP UM H06-19693 A. If a roll paper is utilized that has perforated lines to aid in cutting, it is then possible to have an optical sensor read such a perforated line to determine its position and to position the cutting edge precisely in alignment with the determined position. In such a case, the cutting edge need not be a sharp metallic edge but may be a thin plastic plate whose edge is somewhat sharpened to an extent that it is not injurious. Holding opposite sides of a perforated line firm on paper with the paper pressers as an accessory of cutting and engaging the thin plate with paper along the perforated line can enough cut and sever the paper. Then, even if the safety unit happens to get out of order and the cover is opened when the cutting edge is protruded, the user is freed from injury with the edge portion that is not a cutting edge. Also, utilizing a paper roll with perforated lines allows the automatic cutter to use, instead of cutting with a cutting edge, tearing-off by pulling apart the opposite sides of a perforated line. Methods to read the position of a perforated, line by an optical sensor and to stop paper feed and methods to tear off paper by pulling apart the opposite sides of a perforated line are known as described in detail in JP P 2000-515273 A and JP P H11-244189 A.

Cyclic Action of Automatic Paper Dispensing Device

(15) When the automatic paper cutting device terminates its cyclic operation and the paper pressers 5a and 5b are returned to their initial position to open the paper path, the automatic paper starts to work.

(16) The automatic paper dispensing device in its control unit is programmed to dispense a selected length of paper and then to cease dispensing paper and operates so that when the selected length of paper has been dispensed it ceases dispensing. A length of paper's end portion of 3 am to 8 cm suspended from the casing main body is determined as suitable and selected. Such a control unit is known, simple and efficient that uses a timer to indicate that the selected length of paper has been dispensed.

Return to the Initial State.

(17) When a signal indicating that the automatic paper dispensing device terminates its cyclic operation is issued from its control unit, the controller in the safety device responds to this signal to unclamp the cover 8 that has been locked since when paper started to be pulled out, thereby permitting the cover 8 to be opened to allow the paper roll if necessary to be freely exchanged.

Mention is next made of other embodiments of the present invention.

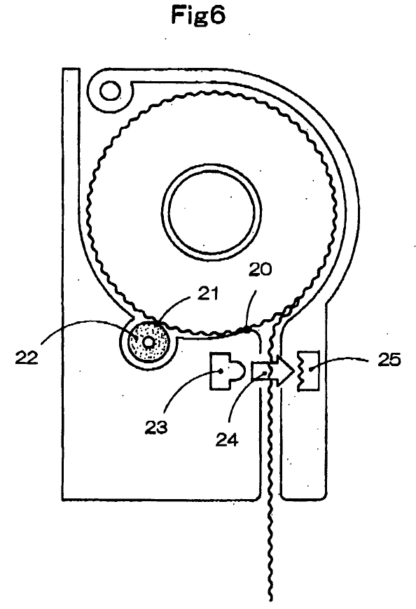

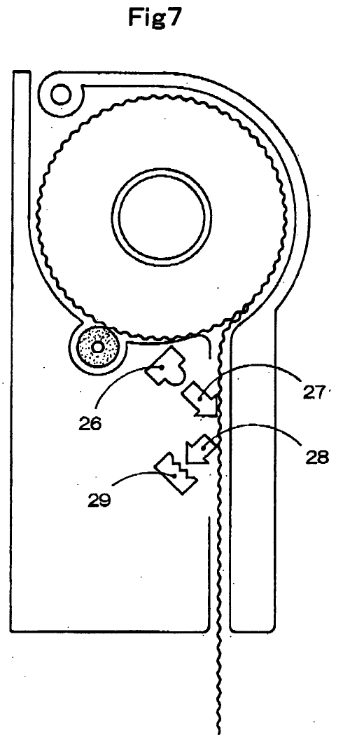

Means for supporting a paper roll rotatably may be other than that which with holders 2a and 2b utilizes a core cylinder of roll as shown in FIG. 1. It may then be one as shown in FIGS. 6 and 7 in which a paper roll is supported rotatably from below with paper supports 20 and 21 one of which 21 may be part of a paper support roll 22 mounted so as to allow paper to be smoothly pulled out from the paper roll as shown and the other of which 20 may also be likewise part of another support roll, although one or both of these support rolls can also be omitted as being not essential.

As to the sensor for reading the paper starting and ceasing to move, a choice may be made among a variety of alternatives in its kinds and methods of mounting.

In Case Sensor Reads Rotation

The holder 2a or 2b shown in FIG. 1 may have a sensor of this type to read rotation of the core cylinder of the paper roll. It is also effective if the rotary shaft of the paper support roll 22 in FIG. 6 has such a sensor. Alternatively, the rotary shaft of the drive roller 3 or the driven roller 10 may have such a sensor to read the paper starting and ceasing to move.

In Case Sensor is a Photodetector Responsive to Light Transmission

As shown in FIG. 6 light rays from an emitter 23 are passed as indicated by the arrow 24 through paper made of fibers to enter a photodetector sensor 25. As the paper begins to move, the paper fibers ahead of the sensor change in their state, changing the intensity of light rays that enter the photodetector sensor 25 past interstices of paper fibers. The photodetector sensor 25 issues a signal corresponding to the intensity of the light rays it receives and this signal is transmitted to the control unit. The control unit judges the paper as moving as long as the signal it receives is changing and judges that the paper has completely ceased to move in response to the signal that is unchanging after a preset lapse of time.

In Case Sensor is a Photodetector Responsive to Light Reflection

As shown in FIG. 7 light rays from an emitter 26 runs as indicated by the arrow 27 and is reflected by the surface of paper of fibers as indicated by the arrow 28 to enter a photodetector sensor 29. As the paper begins to move, the paper fibers ahead of the sensor change in their state, changing the intensity of light rays that enter the photodetector sensor 29 upon reflection by the surface of paper fibers. The photodetector sensor 29 issues a signal corresponding to the intensity of the light rays it receives and this signal is transmitted to the control unit. The control unit judges the paper as moving as long as the signal it receives is changing and judges that the paper has completely ceased to move in response to the signal that is unchanging after a preset lapse of time. Any such sensor having the same functional level as that which is utilized in an image sensor mouse for a personal computer is capable of completely reading even a slight movement of paper and its ceasing.

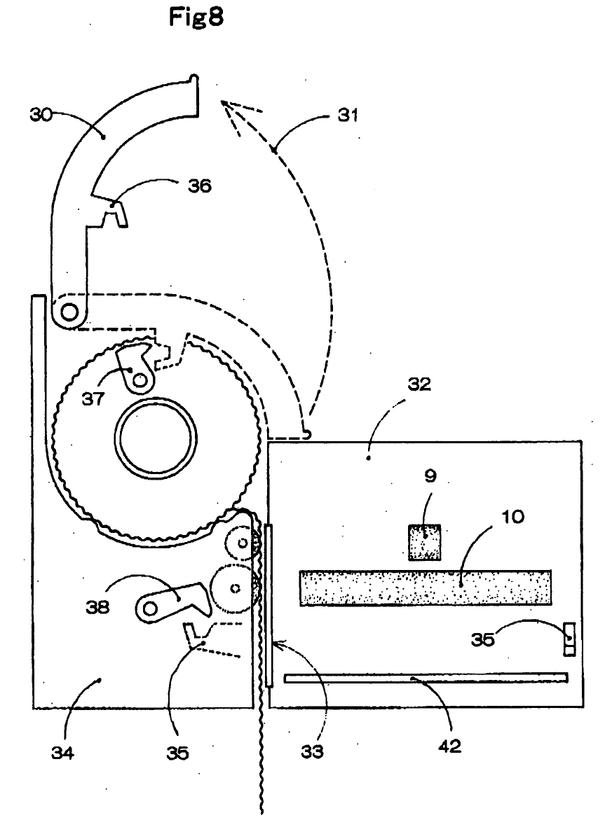

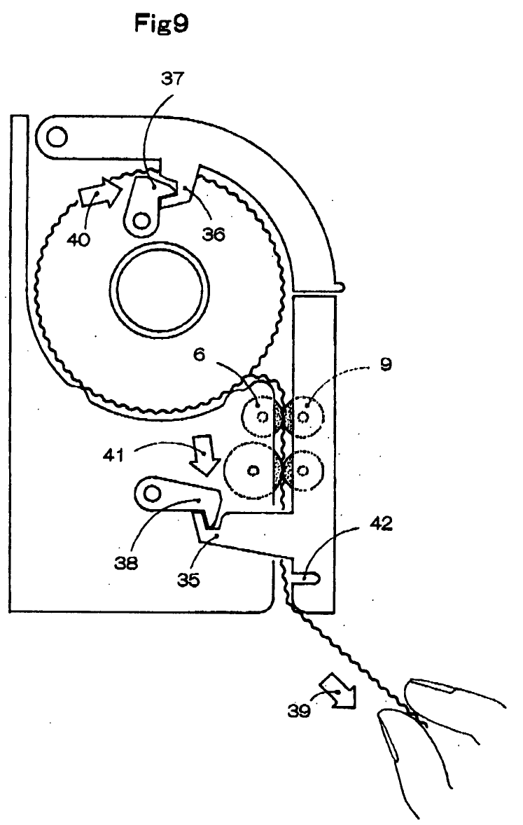

FIG. 8 is a schematic structural and explanatory view illustrating a modified embodiment in which the cover 8 for opening the main body in FIG. 1 is divided at a position somewhat above the sensor driven roller 9 into an upper and a lower cover 30 and 32. The upper cover 30 is configured so that it can be turned up as indicated by the arrow 31 to open the space below it, thereby enabling a paper roll to be set therein whereas the lower cover 32 receiving the sensor driven roller 9 and the driven roller 10 is configured so that it can be opened laterally. This is one of the possible embodiments not provided with the holders 2a and 2b utilizing the core cylinder of a paper roll to support it rotatably. The lower cover 32 is attached to a casing main body 34 with a vertical hinge 33 about which it can be turned to its open and closed positions, and is provided with a locking hook 35. The locking hook 35 is also shown with dotted lines to indicate its position for reference when the lower cover 32 is closed. The upper cover 30 is provided with a locking hook 36, too, and the casing main body 36 is provided in its inner walls with an upper and a lower locking element 37 and 38 for safety. With the paper roll set as shown in FIG. 8, when the user begins to pull paper in the direction of the arrow 39 as shown in FIG. 9, the sensor 9 reads movement of the paper caught between the sensor 9 and the sensor driven roller to send a signal to the control unit in the safety device. Then, the control unit in the safety device causes the upper and lower cover locking elements 37 and 38 to move in the directions of arrows 40 and 41, respectively, whereby the upper and lower covers 30 and 32 are kept clamped until a series of automatic cycles, namely the automatic paper cutting and dispensing cycles after the user ceases pulling out the paper are accomplished. When these automatic cycles are completed, the control unit in the safety device returns the upper and lower cover locking elements 37 and 38 to their initial position where one can, if necessary, exchange the paper roll and clean the entire apparatus. In the apparatus shown in FIGS. 8 and 9, a recess 42 is shown provided in which to accept the cutting edge.

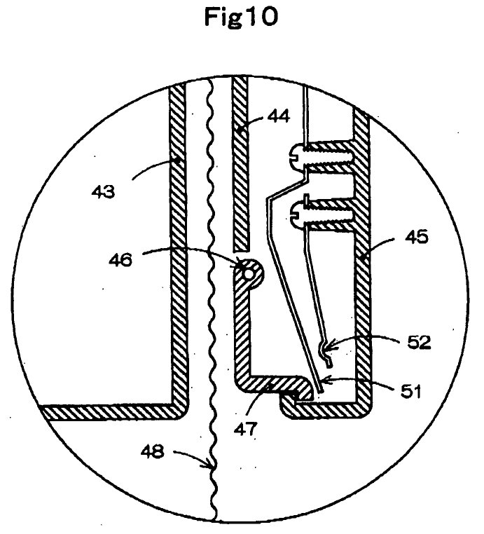

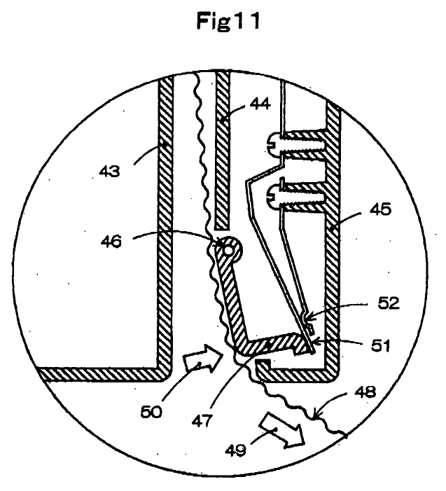

FIGS. 10 and 11 show an embodiment according to claim 5 in particular and are cross sectional views thereof in a region of the paper outlet port. Referring to FIG. 10, the spacing between the inner wall 43 of the casing main body and the inner wall 44 of the cover is about 2 mm to 3 mm, and the cover has an outer covering member 45 having a swing member 47 attached thereto via a fulcrum shaft 46. Although the swing member 47 works better if it is wider in breadth than paper, it still functions enough if its breadth is as narrower as 3 cm to 5 cm when it is centered about paper. Having been dispensed by the automatic dispensing device, paper 48 is shown suspended spontaneously along midway between the inner wall 43 of the casing main body and the inner wall 44 of the cover.

FIG. 11 shows the state that the 48 is pulled in the direction of arrow 49. When paper 48 is pulled in the direction of arrow 49, the swing member 47 is turned about the fulcrum shaft 46 in the direction of arrow 50 to bring a metal piece 51 into engagement with a projection on a metal piece 52. Contacting the metal piece 51 with the metal piece 52 passes a trigger current in an overall control unit for the apparatus, which causes a power supply for each other sensor to be turned and held on to make and hold it operative. This also causes a power supply for each of the respective control units for the automatic paper dispensing device, automatic paper cutting device and safety device to be turned and held on to make and hold them operative to work under a program. Serving thus as a trigger switch, the metal pieces 51 and 52 may as a matter of course be replaced with a micro-switch product available in the market. To facilitate its understanding, the trigger switch is shown in the embodiment of FIGS. 10 and 11 as disposed in a region of the exit of the paper path, where the trigger switch could be directly touched with a finger of a user, however. A trigger switch is so subtly made up and generally is set up in a manner such that it is sensitive to even a slight movement of paper and it could be a cause of the apparatus malfunctioning if a user's finger touches any of its delicate parts. In such consideration, the trigger switch is preferably disposed in the paper path somewhat distant from its exit. Then, the inner wall 43 of the casing main body may in part be concaved in a smooth doglegged form and the swing member 47 in part deformed to correspond thereto so that paper can pass between them (with a spacing of 2 mm to 3 mm) while being suspended by gravity in such a doglegged form. While the trigger switch is sensitive, it can be set so it does not react to such a low force of gravity. When a user is going to pull out paper in such a state, the paper deformed by gravity into the smooth doglegged form is straightened taut by tension and then forces the convexed swing member 47 to turn, thereby bringing the metal piece 51 into contact and electrical contact with the metal piece 52.

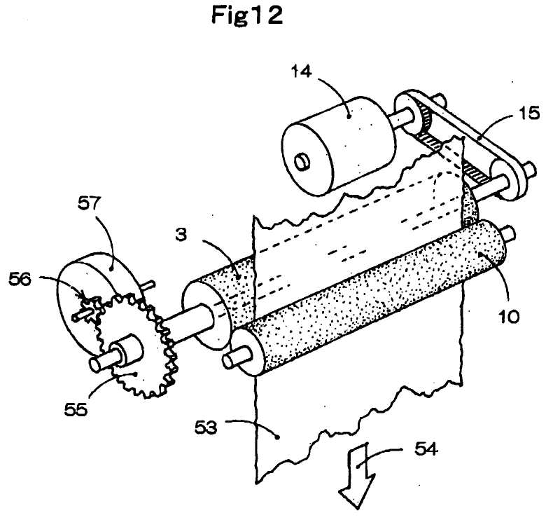

As regards other possible forms of the trigger switch, shown next is a specific embodiment that uses a switch utilizing a centrifugal force. FIG. 12 shows a state that paper 53 is put between the drive roller 3 and the driven roller 10 in FIGS. 1 and 2 and is pulled in the direction of arrow 54. The shaft of the drive roller 3 is equipped with a one-way clutch to allow the drive roller 3 to rotate unaffected by the motor 14 and the power transmission belt 15 but following the movement of paper 53. A gear wheel 55 attached to the drive roller 3 engages with a pinion 56 to provide a speed increasing gear, and an centrifugal switch 57 attached to the shaft of the pinion 56 can acquire enough torque and be turned on in response to even a slight movement of paper 53. A trigger current is passed from the centrifugal switch into its control unit to cause a power supply for each other sensor to be turned and held on to make and hold it operative. This also causes a power supply for each of the respective control units for the automatic paper dispensing device, automatic paper cutting device and safety device to be turned and held on to make and hold them operative to work under a program. A trigger switch working equally to those shown in FIGS. 10 and 12 can be produced by utilizing a permanent magnet to indirectly make an electrical contact. The centrifugal switch can be enough of an inner structure that has been well known with a certain light emitting toy.

Turning a centrifugal switch horizontally by utilizing a bevel gear is also effective to enhance the sensitivity of a sensor. Further, other than usual centrifugal switches internally equipped with a spring, weight and electrical contact, there may be used one that utilizes mercury charged with a metallic ball. As mentioned above, using a trigger switch first acting and adapted to be operated when paper begins to be pulled out to turn on the power supply for a sensor for reading or sensing the paper starting and ceasing to move, thereby making the sensor then first operative, provides the energy-saving effect to make power consumption by the roll paper feeder not in use completely zero. This and other sensors then actuated to electrically control devices are thereafter held energized electrically to continue monitoring constantly. If an optical stimulus or electrical or physical stimulus is applied to each sensor, then the control unit connected to the sensor compares states before and after the stimulus is applied and reads a change between them to operate and control operations of respective devices connected to such control units under a preestablished program.

Therefore, in providing a roll paper feeder of independent type when it is to be fed with a dry battery as a source of limited energy, where it is not profitable at all to keep a sensor energized even with small current for 24 hours a day, the use of a trigger switch is extremely effective to enhance the effect of power saving. Of course, if a household power supply that can be used exclusively for the roll paper feeder is prepared in a place, such as a toilet room, in which it is to be installed, it is needless to say that there can then be used a standard electrical, optical or physical sensor that needs to be continuously fed with electric power for 24 hours a day. Although several form of the trigger switch are shown in and described in connection with FIGS. 11 and 12 together with possible manners in which to power on the sensors utilizing the trigger current, the term “trigger switch” used here means nothing but a sensor means that physically detects or is responsive to the movement of paper which begins when the user commences pulling out paper upon seizing its end to generate an electric signal indicative of it. Mention is next made of embodiments which start a program running for control units in response to a signal from a sensor (including a trigger switch) that reads an instant at which paper begins to be pulled out from a movement of the paper to cyclically operate the automatic paper dispensing and cutting devices. While an automatic paper dispensing and cutting apparatus has been known that requires a switch, e. g. in the form of a push button, on its face to start its operation, the invention is designed to eliminate and get rid of such an externally mounted switch (including any proximity switch as a substitute for such switch as the bush-button, positioned so as to be visible to the user) in the prior art and instead to exploit a sensor (including trigger switch) designed to sense the user's will by monitoring movement of paper to start the apparatus by starting a program to run for its required cyclic operations in response to a signal from the sensor. Starting such a program to run allows the automatic paper dispensing device to operate by dispensing a length of paper set to be suitable for use and then the automatic paper cutting device to operate by cutting paper and thereafter the automatic paper dispensing device to operate again by dispensing paper to an extent that a length of paper suitable for the user to hold with fingers is suspended from the paper exit port, namely to where the initial state of the cycle is restored to wait for a next user pulling out the paper. Thus, even in case a user is one-armed for any reason what-soever to use the apparatus, unlike in the prior art the end of paper comes to be firmly held with its fingers before the paper begins to be dispensed, so there could be no unsanitary situation brought about as might be the case in the prior art that paper forcibly dispensed after the switch is turned on is suddenly cut out of the user's hand and a cut of paper fails to be grasped by the user and comes to eventually fall on the floor. It should be noted here that a trigger switch to constitute a sensor as mentioned above may be disposed anywhere in the paper path or on any shaft rotating in relation to movement of roll paper. If the known automatic roll paper feeding and cutting apparatus with the externally mounted start switch is used one-handed, then the paper must begin to be automatically dispensed forcibly instantaneously when the switch is pushed down (or when the proximity switch utilizing infrared rays is reacted), requiring that the user quickly grasp the end of paper with the one hand used to depress the switch. It is then altogether possible that while the user is trying to grasp, a given length of paper may have already been dispensed and cut, then falling on the floor. This situation is very likely to occur if the user is a physically or mentally handicapped person. Also, if a blind person is utilizing an automatic roll paper dispensing and cutting apparatus according to the prior art, a first problem will be to find if and where the start switch is, and also as can readily be imagined it will not be working well for some time at the beginning to aptly grasp paper unless there is something to catch the paper. According to the present invention, no such difficulty can be met since the apparatus is allowed to start operations only after the user has firmly grasp the end of paper and begins to pull it out.

Thus, a blind person as a user can use this novel roll paper feeder according to the invention in the same sense as that in which the user uses the conventional paper holder well accustomed to use. Further, with no vision switch (no push button which it is instructed by vision to depress and no proximity switch which it is instructed by vision to bring a hand near) and with no instructions to use required, this novel roll paper feeder according to the present invention if replaced suddenly one day, e. g., in a home for such persons, for the paper holder so far well accustomed for them to use can smoothly be introduced there, where users will have no sense of incompatibility except that they might only feel that the paper holder may have been something renewed. A user in using the roll paper feeder might once or twice feel such a surprise that “There, paper's coming out!”, but since he/she has already seized the end of paper to pull it out and noting that the paper is being dispensed, will no longer be confused if the paper is automatically cur, and will soon have an agreeable sense of use of the apparatus.

Since the present invention in its implementation relates primarily to how a sensor, among others, may be mounted for reading or sensing paper starting and ceasing to move and operated, explanations in further detail of the power supply, wiring, electronic control system, centrifugal switch and so on can be omitted. It should be appreciated that the present invention is not limited to the embodiments so far described and its form of implementation may be varied depending on modifications of components and the manner in which they are mounted. For example, the embodiment shown in FIGS. 8 and 9 may be modified to eliminate the upper cover 30 having the locking hook 36 together with the upper cover locking element 37 to provide a modification, referred to as Modification A. It omits a cover and a cover locking means which are provided to ensure safety of and to make trouble-free the apparatus. In Modification A where the cover is omitted, a user's hand may touch and hold down a paper roll while paper is being dispensed from it. Then, the paper might be torn off on the paper roll if the pulling force by the dispensing device exceeds the paper's strength. Or, an excess load may be imposed on the dispensing device that is not enough in durability and a repetition of this may result in a gear damaging and a dispensing roll being worn away to an extent that paper cannot be well dispensed and/or to an extent that the motor and circuit boards get heated and out of order. This modification, which thus makes the apparatus less complete in its integrity and the elimination of possible troubles, will yet be a useful product that can be marketed at a reduced price by cost reduction and which if broken can encourage re-purchasing, thus still opening a new valuable business opportunity to the consumer market.

An example of application of Modification A in which it is mounted beneath a paper holder that has already been installed in a toilet room in a house in general will be described below as Application A. In the existing paper holder unlike the embodiment shown in FIGS. 8 and 9, a paper roll is set by axially supporting its core cylinder so the roll can be rotated about its axis. In this application, Application A, therefore, a roll of paper is so set by utilizing the existing paper holder, and then paper is pulled out a little longer so that paper can be caught by Modification A. A yardstick is to extend paper so its end reaches a position shown in FIG. 8. So doing enables a user to pull out paper one-handed easily to allow it to be cut safely. With the locking hook 35 brought into engagement with the locking element 38 to prevent the lower cover 32 from opening, the cutting edge is protected against exposure and the user against injury, so due safety is ensured. Although there exists the fear that the paper roll may be touched and pushed down, possibly causing a trouble, one may aptly say that this is not bad as it is. In the present invention designed to precisely read the user's will and allow paper to be pulled out with one hand and then to be automatically cut, such components as a cover, a cover locking means and a means to support a paper roll rotatably can be included to make the apparatus easy to use, safe, free of trouble and high in quality but are not components absolutely essential. In Application A, the user need not detach and dispose of the existing paper holder already installed and simply need to purchase and install a Modification A product reduced in price by omitting several components. Viewed from the standpoints of less expensiveness, less laboriousness and less waste emission, the modification A thought to be less complete in integrity and durability becomes an embodiment that is gentle to people of standard and lower income levels and that is gentle to the environments. Reading an instant at which paper begins to be pulled out is to precisely read the user's will or wish to “begin to pull out paper now”, and reading an instant at which paper has ceased to be pulled out is to precisely read the user's will or wish “to cut paper around here because such length is enough”. In the present invention, the apparatus is not allowed to start operation simply if the use's hand is approached or if paper is only lightly touched. It judges that “the user has pulled paper or needs a sheet of paper” first and only when the paper has been grasped and begun to be pulled out. By monitoring a movement of the paper, the apparatus precisely reads the user's will. Any action of bringing the hand near to the apparatus or touching the paper lightly with no intent to pull out the paper is not regarded as an action done requiring a sheet of paper. Accordingly, the present invention provides a roll paper feeder that is capable of operation upon precisely reading the user's will.

Industrial Applicability

From the foregoing, it will be appreciated that the present invention provides a roll paper feeder characterized by precisely reading a user's will through a movement of paper. Therefore, it does not require a user to consciously operate it with any switch and allows toilet paper, cooking paper and paper towel to be easily pulled out of a roll by the user one-handed and to be automatically cut safely. In the absence of any particular switch required to operate, the apparatus can be used easily by a mentally or physically handicapped person, a person one-armed for any reason such as injury, a young child, an aged person or a person lost of vision without much a sense of incompatibility even at its first use and in a manner as accustomed as one has been.

1. A roll paper feeder for feeding paper from a paper roll, comprising a sensor means for sensing an instant at which a user begins to pull out the paper from a movement of the paper; an automatic paper dispensing means adapted to operate automatically under control of a control program; and an automatic paper cutting means adapted to operate automatically under control of the control program.

2. A roll paper feeder for feeding paper from a paper roll, comprising a sensor means for sensing an instant at which a user ceases pulling out the paper from a movement of the paper ceasing; an automatic paper dispensing means adapted to operate automatically under control of a control program; and an automatic paper cutting means adapted to operate automatically under control of the control program.

3. A roll paper feeder as set forth in claim 1, characterized in that it further comprises a safety means having a controller operable
in response to a signal from said sensor means monitoring movement of the paper by sensing either an instant at which the user begins to pull out paper from a movement of the paper or an instant at which the user ceases pulling out the paper from a movement of the paper ceasing
to actuate said safety means so as to maintain the width of a paper passage port in direction of paper thickness to a size sufficient to reject entry of an infant's finger (specifically to 3 mm or less) at least during a paper cutting operation by said automatic paper cutting means.

4. A roll paper feeder as set forth in claim 2, characterized in that it further comprises a safety means having a controller operable
in response to a signal from said sensor means monitoring movement of the paper by sensing either an instant at which the user begins to pull out paper from a movement of the paper or an instant at which the user ceases pulling out the paper from a movement of the paper ceasing
to actuate said safety means so as to maintain the width of a paper passage port in direction of paper thickness to a size sufficient to reject entry of an infant's finger (specifically to 3 mm or less) at least during a paper cutting operation by said automatic paper cutting means.

5. A roll paper feeder as set forth in claim 1, characterized in that it further comprises
a cover means that can be opened to set a paper roll in a main body of the feeder and
a safety means having a controller operable
in response to a signal from said sensor means monitoring movement of the paper by sensing either an instant at which the user begins to pull out paper from a movement of the paper or an instant at which the user ceases pulling out the paper from a movement of the paper ceasing
to actuate said safety means so as to maintain said cover means in the state that the user cannot open it at least during a paper cutting operation by said automatic paper cutting means.

6. A roll paper feeder as set forth in claim 2, characterized in that it further comprises
a cover means that can be opened to set a paper roll in a main body of the feeder and
a safety means having a controller operable
in response to a signal from said sensor means monitoring movement of the paper by sensing either an instant at which the user begins to pull out paper from a movement of the paper or an instant at which the user ceases pulling out the paper from a movement of the paper ceasing
to actuate said safety means so as to maintain said cover means in the state that the user cannot open it at least during a paper cutting operation by said automatic paper cutting means.

7. A roll paper feeder as set forth in claim 2, characterized in that it further comprises
a trigger switch for sensing an instant at which a user begins to pull out the paper from a movement of the paper to provide a signal, and
a power supply circuit for the roll paper feeder, said power supply circuit being adapted to be turned on in response to said signal from said trigger switch, thereby rendering said sensor for monitoring movement of the paper first operative
whereby the roll paper feeder when not in use consumes no power at all and thus is an energy-saving device.

8. A roll paper feeder as set forth in claim 1, characterized in that it comprises
a sensor for sensing an instant at which a user begins to pull out the paper from a movement of the paper to produce a trigger signal, and
a control unit having said control program installed therein, said control unit being operative in response to said trigger signal to cause
said automatic paper dispensing means to be operated to dispense the paper by a length preset to be suitable for use, then
said automatic paper cutting means to be operated to cut the paper; and then
said automatic paper dispensing means to be again operated to dispense the paper to an extent that a length of the paper that is easy to take up between user's fingers is suspended from a paper exit port of the roll paper feeder whereby an initial state is restored to wait for a next user to pull out the paper.
